(19) United States
(12) Patent Application Publication
(10) Pub. No.: US 2009/0152416 A1
(43) Pub. Date: Jun. 18, 2009

(54) JUNCTION BOX MOUNTING BRACKET

(75) Inventor: Junyoung KIM, Seoul (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/255,774

(22) Filed: Oct. 22, 2008

(30) Foreign Application Priority Data
Dec. 13, 2007 (KR) 10-2007-0130041

(51) Int. Cl. H02G 3/08

(52) U.S. Cl. 248/205.1

(57) ABSTRACT

A junction box mounting bracket includes a body including a flat surface and side guide flanges extending inwardly from opposite ends of the body, extension ends extending inwardly from the side guide flanges, side-welding protrusions extending from the extension ends away from the body, the side-welding protrusions being dimensioned and configured for welding the mounting bracket to a housing wall of an engine compartment, and the extension ends being dimensioned and configured to form a gap between the side guide flanges and the housing wall, a stopper flange extending along an upper surface of the body, and/or a clip-insertion hole that opens through the flat surface of the body.

### CROSS-REFERENCE TO RELATED APPLICATION

The present application claims priority to Korean Application Number 10-2007-0130041 filed on Dec. 13, 2007, the entire contents of which is incorporated herein for all purposes by this reference.

### BACKGROUND OF THE INVENTION

1. Field of the Invention

The present invention relates to a mounting bracket, particularly a junction box mounting bracket.

2. Description of Related Art

In general, a junction box is mounted to a shock absorber housing wall after decking an engine in the assembly process of a vehicle.

This work is generally performed after forming a mounting hole and a nut-welding structure to the shock absorber housing wall, in which the worker works with a fastening tool in one hand and a mounting part in the other hand.

However, it is difficult to secure a sufficient space for performing the above work with assembly tools because the engine compartment is small and it is also difficult to perform the work itself because the worker works with a fastening tool and a mounting part in both hands.

In particular, in lay-outs of some kinds of vehicles, the surface of the hood skin is low and the engine is large, and for a rear-battery type, it is difficult to make a package of a junction box and mount the junction box.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention provide for a junction box mounting bracket that makes it possible to mount a junction box by simply pushing it without a space for inserting assembly tools and a specific working space for assembly after engine decking in assembly of a vehicle, because the junction box can be fitted and fastened by being pushed perpendicular to a shock absorber housing wall surface.

Various aspects of the present invention may be directed to a junction box mounting bracket including a body including a flat surface and side guide flanges extending inwardly from opposite ends of the body, extension ends extending inwardly from the side guide flanges, side-welding protrusions extending from the extension ends away from the body, the side-welding protrusions being dimensioned and configured for welding the mounting bracket to a housing wall of an engine compartment, and the extension ends being dimensioned and configured to form a gap between the side guide flanges and the housing wall, a stopper flange extending along an upper surface of the body, and/or a clip-insertion hole that opens through the flat surface of the body.

The body may include an inwardly protruding central-welding portion dimensioned and configured to be welded to the housing wall. The body may also include rigid ribs spaced from the central-welding portion to increase rigidity of the body. The side-welding protrusions may extend at an angle relative to the flat surface of the body such that an upper edge of the body may be spaced further from the housing wall than a lower edge of the body. The body may include a rigid rib to increase rigidity of the body. The rigid rib may protrude inwardly a predetermined length from the body.

The body may include a central-welding portion protruding inwardly from a portion of the body, and the central-welding portion may be dimensioned and configured for welding to the housing wall. The body may include a rigid rib spaced from the central-welding portion to increase rigidity of the body. The rigid rib may be dented inwardly a predetermined distance from the body. The central-welding portion may protrude inwardly from a lower portion of the body. The central-welding portion may protrude inwardly from the body at approximately the same angle relative to the body as the side-welding protrusions. The angle may be an acute angle.

Other aspects of the present invention are directed to an engine compartment of a vehicle including any of the above-mentioned junction box mounting brackets, in which the side-welding protrusions are welded to the housing wall of the engine compartment. A vehicle may include the engine compartment as defined.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIGS. 1(a), 1(b), and 1(c) are views showing the configuration of an exemplary junction box mounting bracket according to an aspect of the invention.

FIG. 2 is a view illustrating that an exemplary junction box mounting bracket is mounted.

FIG. 3 is a view illustrating that an exemplary junction box is mounted by a mounting bracket according to an aspect of the invention.

FIGS. 4(a) and 4(b) are views that an exemplary junction box is combined with a mounting bracket according to an aspect of the invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

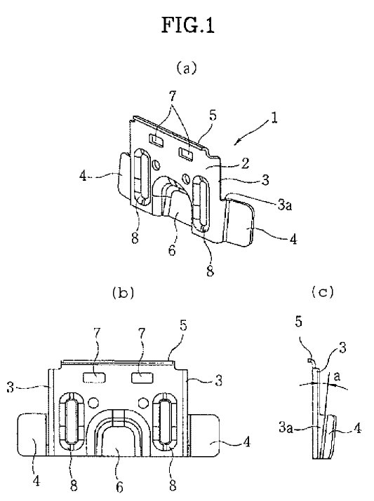

FIGS. 1(a), 1(b), and 1(c) are views showing the configuration of a junction box mounting bracket according to various aspects of the present invention. A junction box mounting bracket 1 according to various embodiments of the present invention includes: a body 2 which may be in the form of a plate having a flat surface; side welding protrusions 4 that bend in the same plane of body plate 2 from side guide flanges 3 extending and bending downwards from both lateral sides of body plate 2, and are welded to a housing box panel 10; a stopper flange 5 that bends upwards along the upper portion of body plate 2; and clip insertion holes 7 that are open through the surface of body plate 2.

Side welding protrusions 4 are integrally formed with a portion of side guide flanges 3 through extension ends 3a. Extension end 3a makes an angle (a) between the body plate 2 and the side welding protrusion 4 such that the width increases upward from the lower portion (the lower end of body plate 2).

Stopper flange 5 bends upwards opposite to the bending direction of side guide flange 3a connected to the side welding protrusion 4 and a pair of clip insertion holes 7 are spaced apart from each other on the body plate 2.

Junction box mounting bracket 1 has a central welding portion 6 to weld the body plate 2 to housing box panel 10 and rigid bids 8 are formed at the other portions than central welding portion 6 on the body plate 2 to increase rigidity of the body plate 2. In various embodiments of the present invention, the rigid bids 8 may be displaced at both sides of central welding portion 6.

The Central welding portion 6 protrudes backwards by pressing body plate 2 with a press and rigid bids 8 protrudes backwards by pressing body plate 2 with a press

The operation of the present invention is described hereafter in detail with reference to the accompanying drawings.

Junction box mounting bracket 1 according to various aspects of the present invention has side welding protrusions 4 and central welding portion 6 to be welded to housing box panel 10 and the body plate 2 with side welding protrusions 4 makes an angle (a) with respect to side welding protrusions 4, such that a gap is formed between body plate 2 and housing box panel 10 when junction box mounting bracket 1 is welded to housing box panel 10. Accordingly, the gap contributes to fit a junction box 20 to junction box mounting bracket 1. Furthermore, since body plate 2 of junction box mounting bracket 1 has clip insertion holes 7, it is possible to firmly fix combined junction box 20.

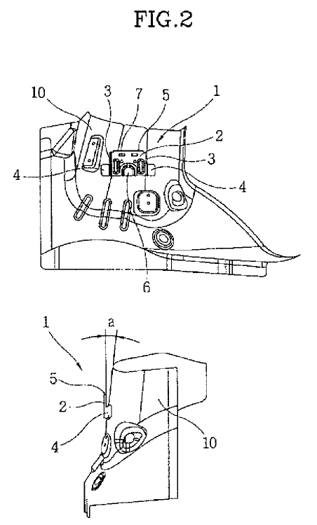

To achieve the above configuration, as shown in FIG. 2, junction box mounting bracket 1 has side welding protrusions 4 that are welded to housing box panel 10 and body plate 12 is mounted to housing box panel 10, spaced apart at the angle (a) by side welding protrusions 4 making the angle (a) from body plate 2.

Furthermore, central welding portion 6, provided to more firmly fix junction box mounting bracket 1 to housing box panel 10, protrudes from body plate 2 and is welded to housing box panel 10.

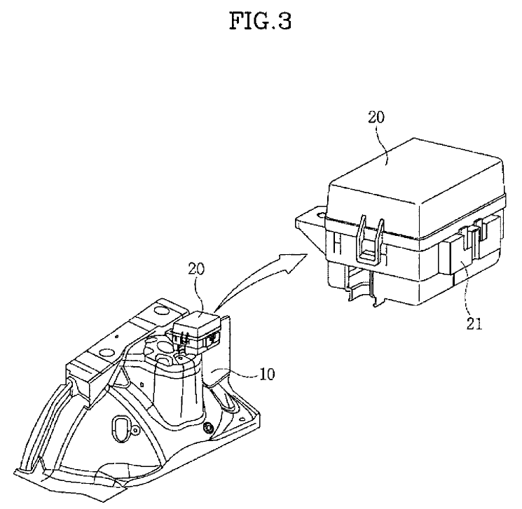

As shown in FIG. 3, connecting ends 21 of junction box 20 are fastened to junction box mounting bracket 1 mounted to housing box panel 10, spaced apart at the angle (a).

When connecting end 21 formed at the side of junction box 20 is locked to junction box mounting bracket 1, connecting ends 21 are fitted into body plate 2 spaced apart at the angle (a) from housing box panel 10 while body plate 2 is positioned inside from connection end 21 and fixes junction box 20.

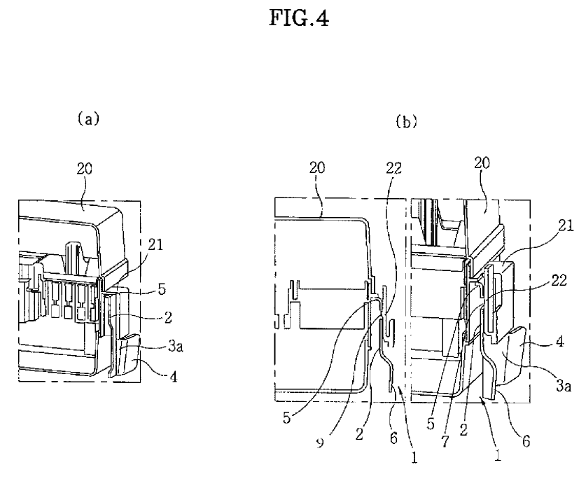

To fasten junction box 20 to junction box mounting bracket 1, as shown in FIG. 4(a), as fitted to body plate 2, connecting ends 21 of junction box 20 are stopped by extension ends 3a of side guide flanges 3 from which side welding protrusions 4 protrude at both side of body plate 2.

The fact that connecting ends 21 of junction box 20 is stopped by extension ends 3a of side guide flanges 3 means that junction box 20 is combined in place.

Connecting ends 21 of junction box 20 fastened to body plate 2 are held at the upper portion of body plate 2 and stopper flanges 5 bending at the upper end of body plate 2 stably hold connecting ends 21.

The gap between housing box panel 10 and junction box mounting bracket 1 where connecting ends 21 of junction box 20 are fitted into is set such that a pressing force is applied to connecting ends 21 from both junction box mounting bracket 1 and housing box panel 10 when connecting ends 21 are fitted.

On the other hand, junction box mounting bracket 1 according to various aspects of the present invention can be used to mounting boxes having a variety of structures, such that, for example, it is possible to combine junction box 20 having locking protrusions 22 formed at connecting ends 21 at the sides, in the fitting way, as shown in FIG. 4(b).

That is, as connecting ends 21 of junction box 20 are fitted to body plate 2, connecting ends 21 are stopped by extension ends 3a of side guide flanges 3 bending from both sides of body plate 2 while locking protrusions 22 protruding inside from connecting ends 21 and having a clip 9 are fitted in open clip insertion holes 7 of body plate 2.

As described above, even if having a complex fastening structure, junction box 20 can be easily mounted by fitting locking protrusions 22 formed at connecting ends 21 of junction box 20 into clip insertion holes 7 formed through body plate 2 of junction box mounting bracket 1.

According to junction box mounting bracket of the invention, since the junction box is perpendicularly pushed and fitted to be mounted to the shock absorbing housing panel that is the side of an engine compartment, a space for inserting assembly tools and a specific working space for assembly are not needed and the assembly process is simplified.

Furthermore, since the a specific assembly space is not needed to mount the junction box to the shock absorber housing wall, it is possible to simply mount the junction box to vehicles having lay outs in which the surface of the hood skin is low and the engine is big, including a rear-battery type.

For convenience in explanation and accurate definition in the appended claims, the terms “upper”, “downwards” or “lower”, “rear”, “inside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A junction box mounting bracket comprising:
a body including a flat surface and side guide flanges extending inwardly from opposite ends of the body;
extension ends extending inwardly from the side guide flanges;
side-welding protrusions extending from the extension ends away from the body, the side-welding protrusions being dimensioned and configured for welding the mounting bracket to a housing wall of an engine compartment, and the extension ends being dimensioned and configured to form a gap between the side guide flanges and the housing wall;
a stopper flange extending along an upper surface of the body; and
a clip-insertion hole that opens through the flat surface of the body.

2. The junction box mounting bracket as defined in claim 1, wherein the body includes an inwardly protruding central-welding portion dimensioned and configured to be welded to the housing wall, the body also including rigid ribs spaced from the central-welding portion to increase rigidity of the body.

3. The junction box mounting bracket as defined in claim 1, wherein the side-welding protrusions extend at an angle relative to the flat surface of the body such that an upper edge of the body is spaced further from the housing wall than a lower edge of the body.

4. The junction box mounting bracket as defined in claim 1, wherein the body includes a rigid rib to increase rigidity of the body.

5. The junction box mounting bracket as defined in claim 4, wherein the rigid rib protrudes inwardly a predetermined length from the body.

6. The junction box mounting bracket as defined in claim 1, wherein the body includes a central-welding portion protruding inwardly from a portion of the body, the central-welding portion being dimensioned and configured for welding to the housing wall.

7. The junction box mounting bracket as defined in claim 6, wherein the body includes a rigid rib spaced from the central-welding portion to increase rigidity of the body.

8. The junction box mounting bracket as defined in claim 7, wherein the rigid rib is dented inwardly a predetermined distance from the body.

9. The junction box mounting bracket as defined in claim 7, wherein the central-welding portion protrudes inwardly from a lower portion of the body.

10. The junction box mounting bracket as defined in claim 6, wherein the central-welding portion protrudes inwardly from the body at approximately the same angle relative to the body as the side-welding protrusions.

11. The junction box mounting bracket as defined in claim 10, wherein the angle is an acute angle.

13. An engine compartment of a vehicle comprising the junction box mounting bracket as defined in claim 1, wherein the side-welding protrusions are welded to the housing wall of the engine compartment.

14. A vehicle comprising the engine compartment as defined in claim 13.
